(19) United States
(12) Patent Application Publication
(10) Pub. No.: US 2014/0259956 A1
(43) Pub. Date: Sep. 18, 2014

(54) LATCH ASSEMBLY

(71) Applicant: Pella Corporation, Pella, IA (US)

(72) Inventors: Todd A. Bernhagen, Pella, IA (US); Derek D. Anderson, Otley, IA (US); Jeff S. Van Zante, Pella, IA (US)

(21) Appl. No.: 14/212,353

(22) Filed: Mar. 14, 2014

Related U.S. Application Data
(60) Provisional application No. 61/793,992, filed on Mar. 15, 2013.

(51) Int. Cl. E05C 1/00; E05C 19/00

(52) U.S. Cl. CPC E05C 1/006; E05C 19/00
USPC 49/503; 292/138; 292/163

(57) ABSTRACT

A latch assembly as provided includes a latch bolt configured to engage a frame at an earlier position than a standard bolt and/or to urge the window or door toward a secured position.

### CROSS-REFERENCE TO RELATED APPLICATION

This application claims priority to Provisional Application No. 61/793,992, filed Mar. 15, 2013, which is herein incorporated by reference in its entirety.

### BACKGROUND

Various aspects of this disclosure relate generally to latch assemblies. Some embodiments relate to latch assemblies for a window or door configured to engage a frame at an earlier position than a standard bolt and/or to urge the window or door toward a secured position.

### SUMMARY

Provided herein is a window assembly including a latch assembly. The window assembly has a released position and a secured position and comprises a frame including a frame member defining an opening for receiving a latch bolt and having a receiving edge. The window includes a sash having a sash member having an end adjacent the window frame member when the window assembly is in a secured position. A latch assembly is secured to the sash member adjacent the end of the sash member and includes a housing having a channel, a latch bolt defining an engagement portion and maintained in the channel, where the latch bolt defines an extended position in which the engagement portion of the latch bolt is extended from the housing, and a retracted position in which the latch bolt is more retracted into the housing relative to the extended position. The engagement portion is configured to engage with the opening in the frame member when the window assembly is in a secured position and includes an engagement edge that is generally parallel to the channel and configured to rest adjacent the receiving edge of the opening in the frame member when the window assembly is in a secured position; a reverse lead in edge generally extends from the engagement edge and is configured to contact the receiving edge before the engagement edge contacts the receiving edge as the window assembly is moved from the released position to the secured position and to urge the window assembly toward the secured position when it contacts the receiving edge; and a lead in edge that meets the reverse lead in edge at a transition point along an axis parallel to the engagement edge, and is located generally opposite the engagement edge and angled such that a component of a force applied to the lead in edge when the window is moved toward a secured position urges the latch bolt toward a retracted position. The latch assembly further includes a biasing member configured to urge the latch bolt toward the extended position.

In some embodiments, the reverse lead in edge extends from the engagement edge at an acute angle as measured along an axis parallel with the engagement edge. In some embodiments, the acute angle is from 10° to 80°.

In some embodiments, the angle formed between the lead in edge and the axis parallel to the engagement edge is unequal to the angle formed between the reverse lead in edge and the axis.

In some embodiments, the biasing member applies a force of from about 0.005 pounds to about 25 pounds to bias the latch bolt toward the extended position.

In some embodiments, the biasing member has a spring rate of from about 0.5 pounds per inch to about 20 pounds per inch. In some embodiments the biasing member has a spring rate greater than 2 pounds per inch, for example about 5.6 pounds per inch, about 9.8 pounds per inch, about 10 pounds per inch.

In some embodiments, the latch assembly is a tilt latch assembly.

In some embodiments, the biasing member is a coil spring.

A latch bolt assembly is provided herein that includes a housing having a channel, a latch bolt, and a biasing member configured to urge the latch bolt toward an extended position. The latch bolt defines an engagement portion and is configured to be housed within the channel, where the channel permits travel of the latch bolt between an extended position in which the engagement portion of the latch bolt is extended from the housing, and a retracted position in which the latch bolt is more retracted into the housing relative to the extended position. The engagement portion is configured to engage with a receiving edge of an opening in a frame member and includes an engagement edge that is generally parallel to the channel and configured to rest adjacent to the receiving edge of the opening in the frame member when the engagement section of the latch bolt is engaged with the opening; a reverse lead in edge that generally extends from the engagement edge at an acute angle as measured along an axis parallel with the engagement edge; and a lead in edge meeting the reverse lead in edge at a transition point along an axis parallel to the engagement edge, where the lead in edge is located generally opposite the engagement edge and angled such that a force applied to the lead in edge urges the latch bolt toward a retracted position.

In some embodiments, the acute angle measured between the reverse lead in edge and the axis parallel with the engagement edge is from 10° to 80°.

In some embodiments, the angle formed between the lead in edge and the axis parallel to the engagement edge is unequal to the angle formed between the reverse lead in edge and the axis.

In some embodiments, the angle formed between the lead in edge and the axis parallel to the engagement edge is between 10° and 80°.

In some embodiments, the biasing member applies a force of from about 0.005 pounds to about 25 pounds to bias the latch bolt toward the extended position.

In some embodiments, the biasing member applies a spring rate of from about 0.5 lbs-in to about 20 lbs-in. In some embodiments the biasing member applies a force greater than 2 lbs-in, for example about 5.6 lbs-in, about 9.8 lbs-in, about 10 lbs-in, or about 20 lbs-in, for example, to the latch bolt toward the extended position.

In some embodiments, the latch assembly is a tilt latch assembly.

In some embodiments, the biasing member is a coil spring.

While multiple embodiments are disclosed, still other embodiments of the present invention will become apparent to those skilled in the art from the following detailed description, which shows and describes illustrative embodiments of the invention. Accordingly, the drawings and detailed description are to be regarded as illustrative in nature and not restrictive.

While multiple embodiments are disclosed, still other embodiments of the present invention will become apparent to those skilled in the art from the following detailed description, which shows and describes illustrative embodiments of the invention. Accordingly, the drawings and detailed description are to be regarded as illustrative in nature and not restrictive.

### BRIEF DESCRIPTION OF THE DRAWINGS

FIG. 1 is a window in a secured position, according to an embodiment.

FIG. 2 is a window in a tilted open, released position, according to an embodiment.

FIG. 3 is a latch assembly in a sash member, according to an embodiment.

FIG. 4 is a schematic of a latch bolt, according to an embodiment.

FIG. 5 is a schematic of a latch assembly, according to an embodiment.

### DETAILED DESCRIPTION

Some aspects of this disclosure relate generally to embodiments of a latch assembly, and more specifically to a latch assembly (e.g., on a window sash or door) which includes a latch bolt configured to engage an opening in a frame member (e.g., a window frame or door frame) at an earlier position than a standard latch bolt. In some embodiments, a latch bolt provided herein is configured to urge the latch assembly toward the secured position.

As used herein, the term “released position” generally relates to a window sash being tilted open and/or removed from the window frame (e.g., for cleaning) while “secured position” relates to a window sash being received in a window frame for operational use (e.g., to be transitioned between a vented, or open position and a non-vented, or closed position).

As illustrated in FIG. 1, an embodiment of a latch assembly 10 provided herein can be used as a tilt latch for a window 100. As shown in FIGS. 1 and 2, a window 100 can include a frame 110 having a first side jamb 112, a second side jamb 114, a sill 116, and a head jamb 118. A first sash 120 and a second sash 130 can be provided within frame 110. The second sash 130 has a first stile 132, a second stile 134, a bottom rail 136, and a top rail 138, also described as a check rail or a meet rail. A sash provided herein (e.g., second sash 130) can be moved from a released position (as shown in FIG. 2) to a secured position (as shown in FIG. 1). When in the secured position, at least one sash member (e.g., a stile or rail) has an end (e.g., end 140) that is adjacent a window frame member (e.g., jamb 114).

In some embodiments, a latch assembly 10 can be attached to or embedded in a sash member (e.g., a stile or a rail of a sash) adjacent to the end (e.g., end 140) of the sash member (e.g., rail 138) as shown in FIGS. 3, 4, and 5. As shown in FIG. 3, latch assembly 10 includes a housing 20 having a channel 22, a latch bolt 30 maintained in the channel 22 and defining an engagement portion 40, and a biasing member 60. Housing 20 is configured to allow movement of latch bolt 30 within the channel 22 along axis A from an extended position, in which the engagement portion 40 of the latch bolt 30 is extended from the housing 20, to a retracted position, in which the latch bolt 30 is more retracted into the housing 20 relative to the extended position. In some embodiments, the housing 20 is formed as part of the sash (e.g., a routed channel in the sash member) or as a separate component as desired.

Biasing member 60 is a coiled spring, although the biasing member is optionally another means for applying a biasing force F to the latch bolt 30 in order to urge the latch bolt 30 toward the extended position. For example, biasing member 60 can include a coiled spring, a leaf spring, a deformable material such as rubber or plastic, or other means as appropriate. In some embodiments, the biasing member has a spring rate of from about 0.5 pounds per inch to about 20 pounds per inch. In some embodiments the biasing member has a spring rate greater than 2 pounds per inch, for example about 5.6 pounds per inch, about 9.8 pounds per inch, about 10 pounds per inch.

In some embodiments window 100 including latch assembly 10 has at least one frame member (e.g., a jamb or sill) that defines an opening configured to receive engagement portion 40 when the window 100 is in a secured position. As shown in FIG. 4, opening 70 includes a receiving edge 72 that the engagement portion 40 contacts as sash 130 is moved from a released position to a secured position.

FIGS. 4 and 5 illustrate a prior art latch assembly L including a latch bolt B on the left, and a latch assembly 10 including a latch bolt 30 according to an embodiment of the present invention on the right. Latch assembly 10, on the right, includes a latch bolt 30 having an elongated form along axis A. Engagement portion 40 includes an engagement edge 42, a reverse lead in edge 44, and a lead in edge 46. Engagement edge 42 extends along one side of engagement portion 40 and generally extends in a direction parallel to axis A. When engagement portion 40 engages opening 70, engagement edge 42 is configured to rest adjacent receiving edge 72 and retain sash 130 in a secured position unless latch bolt 30 is moved toward the retracted position using, for example, a handle or tab 24 that is operably linked to latch bolt 30.

In some embodiments, engagement edge 42 is substantially straight, or includes other features as desired (such as bump outs, protrusions, recesses, detents, or other feature).

Reverse lead in edge 44 extends generally from lead in edge 46 along a side adjacent engagement edge 42. Reverse lead in edge 44 is optionally substantially straight, curved, compound curved or other shape as desired. Reverse lead in edge 44 generally forms a lead-in or cut back into the engagement portion 40 opposite the lead in edge 46. In some embodiments, reverse lead in edge 44 extends from engagement edge 42 at an acute angle as measured in the direction of retraction along axis A. In some embodiments, the angle is from about 10° to about 80°, from about 25° to about 75°, from about 30° to about 70°, from about 20° to about 50°, from about 30° to about 60°, from about 45° to about 60°, from about 50° to about 70°, or other angle as appropriate. In some embodiments, as sash 130 is moved from a released position to a secured position, at least a portion of reverse lead in edge 44 contacts receiving edge 72 of opening 70 before the engagement edge 42 does by a distance D. In some embodiments, the reverse lead in edge 44 contacts receiving edge 72 before engagement edge 42 does by a distance D greater than zero, for example of at least 0.01 inches, 0.05 inches, 0.08 inches, 0.09 inches, 0.10 inches, 0.11 inches, 0.12 inches, 0.2 inches, 0.3 inches or more.

In some embodiments, the angle at which the reverse lead in edge 44 extends from the engagement edge 42 can, in combination with the biasing force F from biasing member 60, urge sash 130 toward a secured position when the reverse lead in edge contacts the receiving edge. The biasing force from biasing member 60 or the angle of the reverse lead in edge 44 can be adjusted as desired to change how strongly the sash 130 is urged toward the secured position. In some embodiments, the angle of the reverse lead in edge 44 and the biasing force can be adjusted as desired to change how strongly the sash 130 is urged toward the closed position. For example, biasing force F from biasing member 60 can be from about 0.005 pounds to about 25 pounds of force. In some embodiments, biasing force F can be a force of from 0.005 to 0.5 pounds, from 0.05 to 2 pounds, from 0.25 to 4 pounds, from 0.1 to 10 pounds, from 0.75 to 2.5 pounds, from 1 to 12 pounds, from 5 to 15 pounds, from 2 to 8 pounds, from 10 to 25 pounds, from 0.5 to 15 pounds, from 12 to 20 pounds, or other appropriate value.

Lead in edge 46 extends generally from reverse lead in edge 44 along a side generally opposite engagement edge 42. Lead in edge 46 is optionally substantially straight, curved, compound curved or other shape as desired. Lead in edge 46 generally forms a lead-in or cut back into the engagement portion 40. In some embodiments, the lead in edge 46 forms an acute angle, for example of from about 10° to about 80°, from about 25° to about 75°, from about 30° to about 70°, from about 20° to about 50°, from about 30° to about 50°, from about 30° to about 60°, from about 45° to about 60°, from about 50° to about 70°, or other angle as appropriate with an axis parallel to axis A that generally corresponds to the direction of extension and retraction. In some embodiments, the extensions of lead in edge 46 and reverse lead in edge 44 generally intersect at a transition point along an axis parallel to axis A and unequal angles with the axis parallel to axis A. The lead in edge 46 and reverse lead in edge 44 optionally meet at a transition point have a having a radius of zero (i.e., a sharp point) or the edges 44, 46 meet at a smooth transition point having a non-zero radius (such as a radius of 0.01 inches, 0.02 inches, or more). In other words, in some embodiments, the edges 44, 46 optionally transition smoothly into one another along a curved or smoothed transition point. In some embodiments, a component of a closing force is applied to lead in edge 46 as sash 130 is moved toward a secured position and urges latch bolt 30 toward the retracted position.

Although embodiments of the provided latch assembly have been described herein with relation to a window with a lower sash that tilts on a horizontal axis, it is to be understood that certain embodiments of the provided latch are suitable for use in other applications, such as a door, or a window with a sash that tilts on a vertical axis. Moreover, while the latch assembly has been described in association with a lower sash in the foregoing examples, in various embodiments an upper sash or additional sash optionally includes the latch assembly with complementary latching features associated with the window frame.

Various modifications and additions can be made to the exemplary embodiments discussed without departing from the scope of the present invention. For example, while the embodiments described above refer to particular features, the scope of this invention also includes embodiments having different combinations of features and embodiments that do not include all of the above described features.

Various modifications and additions can be made to the exemplary embodiments discussed without departing from the scope of the present invention. For example, while the embodiments described above refer to particular features, the scope of this invention also includes embodiments having different combinations of features and embodiments that do not include all of the above described features.

The following is claimed:

1. A window assembly having a released position and a secured position, the window assembly comprising:
a frame including a frame member, the frame member defining an opening for receiving a latch bolt and having a receiving edge;
a sash including a sash member having an end adjacent the window frame member when the window assembly is in a secured position; and
a latch assembly secured to the sash member adjacent the end of the sash member, the latch assembly including:
a housing having a channel;
a latch bolt defining an engagement portion and maintained in the channel, the latch bolt defining an extended position in which the engagement portion of the latch bolt is extended from the housing, and a retracted position in which the latch bolt is more retracted into the housing relative to the extended position, the engagement portion configured to engage with the opening in the frame member when the window assembly is in a secured position, the engagement portion including:
an engagement edge, the engagement edge being generally parallel to the channel and configured to rest adjacent the receiving edge of the opening in the frame member when the window assembly is in a secured position;
a reverse lead in edge, the reverse lead in edge generally extending from the engagement edge and configured to contact the receiving edge before the engagement edge contacts the receiving edge as the window assembly is moved from the released position to the secured position and to urge the window assembly toward the secured position when it contacts the receiving edge; and
a lead in edge, the lead in edge meeting the reverse lead in edge at a transition point along an axis parallel to the engagement edge, the lead in edge being located generally opposite the engagement edge and angled such that a component of a force applied to the lead in edge when the window is moved toward a secured position urges the latch bolt toward a retracted position; and
a biasing member configured to urge the latch bolt toward the extended position.

2. The window assembly of claim 1, wherein the reverse lead in edge extends from the engagement edge at an acute angle as measured along an axis parallel with the engagement edge.

3. The window assembly of claim 2, wherein the acute angle is from 10° to 80°.

4. The window assembly of claim 1, wherein the angle formed between the lead in edge and the axis parallel to the engagement edge is unequal to the angle formed between the reverse lead in edge and the axis.

5. The window assembly of claim 1, wherein the biasing member has a spring rate greater than about 2 pounds per inch.

6. The window assembly of claim 1, wherein the biasing member urges the latch bolt toward the extended position with a force of from about 0.005 pounds to about 25 pounds.

7. The window assembly of claim 1, wherein the latch assembly is a tilt latch assembly.

8. The window assembly of claim 1, wherein the biasing member is a coil spring.

9. A latch assembly, comprising:
a housing having a channel;
a latch bolt defining an engagement portion and configured to be housed within the channel, the channel permitting travel of the latch bolt between an extended position in which the engagement portion of the latch bolt is extended from the housing, and a retracted position in which the latch bolt is more retracted into the housing relative to the extended position, the engagement portion configured to engage with a receiving edge of an opening in a frame member, the engagement portion including:
an engagement edge, the engagement edge being generally parallel to the channel and configured to rest adjacent to the receiving edge of the opening in the frame member when the engagement section of the latch bolt is engaged with the opening;
a reverse lead in edge, the reverse lead in edge extending from the engagement edge at an acute angle as measured in the direction of retraction; and
a lead in edge, the lead in edge meeting the reverse lead in edge at a transition point along an axis parallel to the engagement edge, the lead in edge being located generally opposite the engagement edge and angled such that a force applied to the lead in edge urges the latch bolt toward a retracted position; and
a biasing member configured to urge the latch bolt toward the extended position.

10. The latch assembly of claim 9, wherein the acute angle is from 10° to 80°.

11. The latch assembly of claim 9, wherein the angle formed between the lead in edge and the axis parallel to the engagement edge is unequal to the angle formed between the reverse lead in edge and the axis.

12. The latch assembly of claim 11, wherein the angle formed between the lead in edge and the axis parallel to the engagement edge is between 10° and 80°.

13. The latch assembly of claim 9, wherein the biasing member has a spring rate greater than about 2 pounds per inch.

14. The latch assembly of claim 9, wherein the biasing member urges the latch bolt toward the extended position with a force of from about 0.005 pounds to about 25 pounds.

15. The latch assembly of claim 9, wherein the latch assembly is a tilt latch assembly. The latch assembly of claim 9, wherein the biasing member is a coil spring.
